(19) United States
(12) Patent Application Publication
(10) Pub. No.: US 2011/0072447 A1
(43) Pub. Date: Mar. 24, 2011

(54) DISK DRIVE MOTOR

(76) Inventors: Yong Kwan Lee, Gyunggi-do (KR); Nam Seok Kim, Gyunggi-do (KR); Sun Kim, Gyunggi-do (KR)

(21) Appl. No.: 12/622,412

(22) Filed: Nov. 19, 2009

(30) Foreign Application Priority Data
Sep. 24, 2009 (KR) 10-2009-0090583

(51) Int. Cl. G11B 17/028

(52) U.S. Cl. 720/716; G9B/17.006

(57) ABSTRACT

Disclosed herein is a disk drive motor which can prevent a disk from wobbling despite having a simple structure. The disk drive motor includes a turntable which is rotated by a drive unit and supports a disk thereon, and a disk support which is attached onto the turntable to support the disk thereon. Grooves are formed in the disk support. Each groove is inclined based on the radial direction of the turntable in the direction opposite to the direction in which the disk rotates. In the present invention, when a disk rotates, air which has been in a space between the turntable and the disk is discharged outside through the grooves, so that adsorption force is generated by a difference in pressure between the air and the space between the turntable and the disk. Therefore, the disk can be prevented from wobbling when rotating.

### CROSS REFERENCE TO RELATED APPLICATION

This application claims the benefit of Korean Patent Application No. 10-2009-0090583, filed Sep. 24, 2009, entitled “A disk drive motor”, which is hereby incorporated by reference in its entirety into this application.

### BACKGROUND OF THE INVENTION

1. Technical Field

The present invention relates to a disk drive motor.

2. Description of the Related Art

Recently, because of an increasing amount of data being stored, the methods of storing data are changing from electric to optical methods. In the electric method, data is stored by varying the electric capacity and the electric resistance of a place for storing data, and such variation is electrically read. In the optical method, data is stored by varying transmissivity, reflexibility, phase, polarization, etc. of light, and such variation is read using laser beams.

An optical disk is an optical memory medium used by the optical method. A digital audio disk (DAD) which is generally referred to as a CD and used to reproduce audio, and a digital video disk (DVD) are representative examples of optical disks. The optical disk is placed onto a turntable which is rotated by a spindle motor or an ODD motor and reflects a laser beam radiated from a pick-up unit which is moved in the radial direction of the optical disk. The pick-up reads data using transmissivity of the reflected laser beam or a variation in the reflexibility or phase of the beam when it is reflected.

However, in the conventional technique, because the turntable rotates at high speed, the disk placed on the turntable may slip with respect to the turntable or wobble, resulting in the problem of the pick-up unit not being able to precisely read the data. In an effort to overcome the above problem, a technique in which a slip prevention member is attached to the upper surface of the turntable onto which the disk is placed is being developed or used.

FIG. 1 is a schematic sectional view showing a disk drive motor having a slip prevention member, according to a conventional technique. FIG. 2 is a top perspective to view of the disk drive motor of FIG. 1. Hereinafter, the slip prevention structure of the disk drive motor according to the conventional technique will be explained with reference to these drawings.

As shown in FIGS. 1 and 2, in the disk drive motor 10 according to the conventional technique, a rotating shaft 12, which is rotated by a drive unit 14, is fitted at the center of a turntable 16. A slip prevention member 18 is attached to the upper surface of the turntable 16. A disk D is seated onto the slip prevention member 18 such that the disk D can be prevented from slipping with respect to the turntable 16.

Here, the slip prevention member 18 is made of material, such as a rubber sheet, which generates a lot of friction. Furthermore, the slip prevention member 18 has an annular shape and is attached to the perimeter of the upper surface of the turntable 16.

However, the slip prevention member 18 of the conventional technique provides frictional force to the disk which can only prevent the disk D from slipping but cannot prevent the disk D from wobbling in the vertical direction. In particular, when the disk D rotates at a high speed, because the disk D increasingly wobbles, it becomes difficult to read data. Therefore, a technique to solve these problems is required.

### SUMMARY OF THE INVENTION

The present invention has been made in an effort to provide a disk drive motor which can prevent a disk from wobbling in the vertical direction despite having a simple structure.

In a disk drive motor according to an embodiment of the present invention, a turntable is rotated by a drive unit. The turntable has an upper surface onto which a disk is placed. A disk support is attached to the upper surface of the turntable to support the disk thereon. A groove is formed in the disk support. The groove is inclined based on a radial to direction of the turntable in a direction opposite to a direction in which the disk rotates.

The groove may be formed by removing an entire thickness of a portion of the disk support such that the disk support is separated.

The groove may comprise a plurality of grooves spaced apart from each other at regular angular intervals around a center of the turntable. The plurality of grooves may have the same shape.

Furthermore, a width of the groove may be constant from the circumferential inner surface of the disk support to the circumferential outer surface thereof or may be increased from the circumferential inner surface of the disk support to the circumferential outer surface thereof.

The sidewalls of the groove may be linear or curved.

The groove may have a curved shape such that the groove is convex in the direction in which the disk rotates.

The disk support may be attached to a perimeter of the turntable.

The groove may be formed by reducing a thickness of a portion of the disk support.

In a disk drive motor according to an embodiment of the present invention, a turntable is rotated by a drive unit. The turntable has an upper surface onto which a disk is placed. A groove is formed in the upper surface of the turntable. The groove is inclined based on a radial direction of the turntable in a direction opposite to a direction in which the disk rotates.

Furthermore, a perimeter of the upper surface of the turntable may protrude upwards. The groove may be formed in the perimeter of the upper surface of the turntable.

The groove may comprise a plurality of grooves spaced apart from each other at regular angular intervals around a center of the turntable. The plurality of grooves may have the same shape.

In addition, the width of the groove may be constant from the inner end thereof to to the outer end thereof or increase from the inner end thereof to the outer end thereof.

The sidewalls of the groove may be linear or curved.

The groove may have a curved shape such that the groove is convex in the direction in which the disk rotates.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic sectional view showing a disk drive motor having a slip prevention member, according to a conventional technique;

FIG. 2 is a top perspective view of the disk drive motor of FIG. 1;

FIG. 3 is a sectional view of a disk drive motor, according to a first embodiment of the present invention;

FIG. 4 is a sectional perspective view of the disk drive motor of FIG. 3;

FIG. 5 is a detailed view of the circled portion K of FIG. 4;

FIG. 6 is a sectional perspective view of a disk drive motor, according to a second embodiment of the present invention;

FIG. 7 is a sectional perspective view of a disk drive motor, according to a third embodiment of the present invention; and

FIG. 8 is a sectional perspective view of a disk drive motor, according to a fourth embodiment of the present invention.

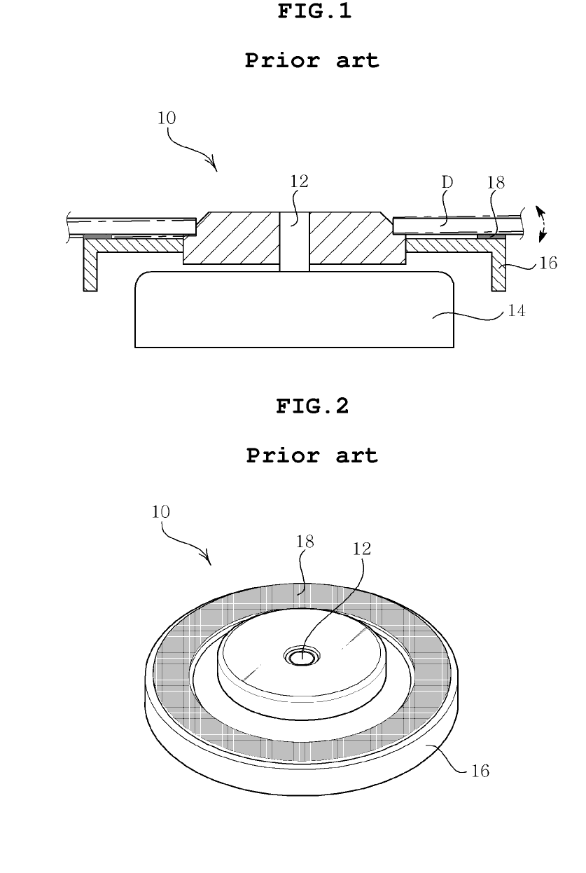

### DESCRIPTION OF THE PREFERRED EMBODIMENTS

Reference now should be made to the drawings, in which the same reference numerals are used throughout the different drawings to designate the same or similar components. In the following description, when it is determined that the detailed description of the conventional function and conventional structure would confuse the gist of the present invention, such a description may be omitted. Furthermore, the terms and words used in the specification and claims are not necessarily limited to typical or dictionary meanings, but must be understood to indicate concepts selected by the inventor as the best method of illustrating the present invention, and must be interpreted as having had their meanings and concepts adapted to the scope and sprit of the present invention so that the technology of the present invention could be better understood.

Hereinafter, embodiments of the present invention will be described in detail with reference to the attached drawings.

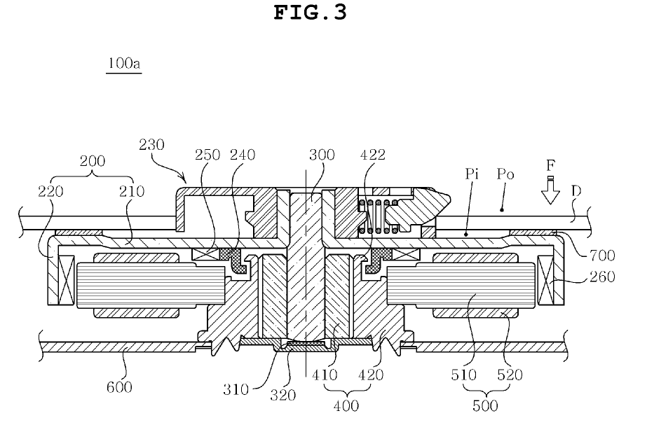

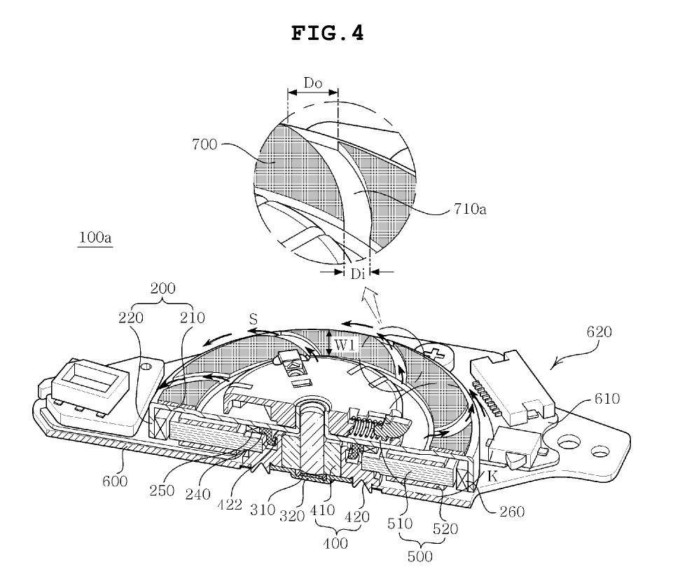

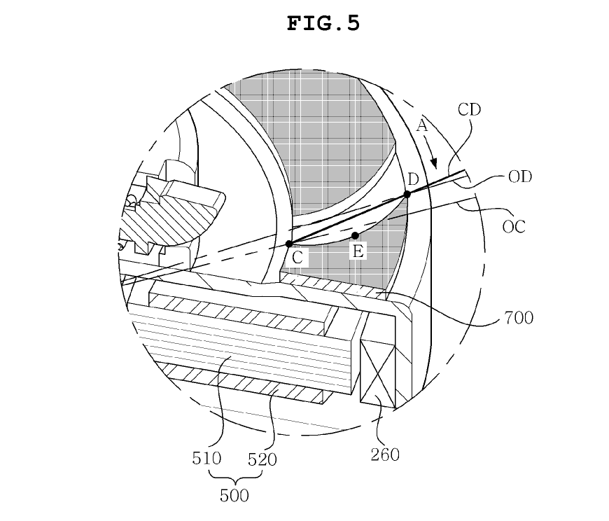

FIG. 3 is a sectional view of a disk drive motor 100a, according to a first embodiment of the present invention. FIG. 4 is a sectional perspective view of the disk drive motor 100a of FIG. 3. FIG. 5 is a detailed view of the circled portion K of FIG. 4. The disk drive motor 100a according to the first embodiment will be explained with reference to these drawings.

As shown in FIGS. 3 through 5, the disk drive motor 100a according to the first embodiment includes a turntable 200 on which a disk is placed, and a disk support 700 which has grooves 710a for discharging fluid.

The disk D is placed on the turntable 200, and the turntable 200 is rotated by a drive unit so that the disk D placed thereon rotates.

In the embodiment, the turntable 200 includes a horizontal circular plate 210 which is force-fitted at the center thereof over a rotating shaft 300 and extends perpendicular to the rotating shaft 300, and an annular bent part 220 which is perpendicularly bent downwards from the outer edge of the horizontal circular plate 210 and defines an inner to space between it and the rotating shaft 300.

Furthermore, a chucking assembly 230 for chucking the disk D is provided on the central portion of the upper surface of the horizontal circular plate 210. A hooking part 240 and/or an attractive magnet 250 are provided under the lower surface of the horizontal circular plate 210 to prevent the turntable 200 from rising up when rotating. In the embodiment, the hooking part 240 engages with a protrusion 422 which is provided on a bearing holder 420, thus functioning to prevent the turntable 200 from rising up. The attractive magnet 250 functions to prevent the turntable 200 from rising up using magnetic attractive force between it and a bearing 410, the bearing holder 420 and/or a stator 500. Here, the bearing holder 420 is mounted to a base plate 600. Meanwhile, in the drawings, although the hooking part 240 and the attractive magnet 250 are illustrated as being disposed at specific positions, this is only one example of the present invention, and the installation locations thereof may be changed so long as they can conduct the function of preventing the turntable 200 from rising up. Furthermore, a main magnet 260 is provided on the inner surface of the annular bent part 220. The main magnet 260, along with the stator 500, generates electromagnetic force using reciprocal action therebetween.

In the drawings, although the turntable 200 has been illustrated as having the structure including the horizontal circular plate 210 and the annular bent part 220, it may be constructed such that a rotor casing having the same structure as that of the turntable 200 is provided and a separate turntable for supporting the disk D thereon is mounted on the rotor casing. Such a modification must be also regarded as falling within the bounds of the present invention.

The turntable 200 is rotated by the drive unit. The drive unit includes the stator 500 which generates electromagnetic force along with the main magnet 260 using reciprocal action therebetween. The drive unit further includes the rotating shaft 300, a bearing unit 400 and the base plate 600.

The rotating shaft 300 supports the turntable 200 thereon and has a cylindrical shape having a predetermined diameter. The circumferential outer surface of the rotating shaft 300 is rotatably supported by the bearing 410. In addition, the lower end of the rotating shaft 300 is axially supported by a thrust washer 310 fastened to a support plate 320.

The bearing unit 400 rotatably supports the rotating shaft 300. In detail, the bearing unit 400 includes the bearing 410 which rotatably supports the circumferential outer surface of the rotating shaft 300, and the bearing holder 420 which is fastened to the base plate 600 and supports the bearing 410 and the stator 500. The inner surface and outer surface of the lower end of the bearing holder 420 are respectively fastened to the support plate 320 and the base plate 600 by caulking or spinning.

The stator 500 generates an electric field using external power applied thereto. The stator 500 includes a core 510 and a coil 520 which is wound around the core 510. The core 510 is fitted over the circumferential outer surface of the bearing holder 420. The coil 520 is wound around the core 510 many times. The coil 520 forms an electric field using power applied thereto to rotate the turntable 200 using force generated between it and the main magnet 260 of the turntable 200.

The base plate 600 functions to support the entirety of the disk drive motor 100a. The base plate 600 is fastened to an apparatus, such as a hard disk drive, in which the disk drive motor 100a is installed. Furthermore, a circuit board 610 is provided on the base plate 600. A circuit (not shown) along which electricity flows to rotate the disk drive motor 100a is formed on the circuit board 610. Here, the circuit board 610 is attached to the base plate 600 by a well-known technique, for example, using double-sided adhesive tape, a coupling screw, a rivet, caulking, etc. Electronic devices 620, such as an encoder, a connector and a passive element, are mounted on the circuit board 610.

The disk support 700 supports the disk D mounted to the turntable 200. Furthermore, the disk support 700 provides frictional force to the disk D to prevent the disk D from slipping relative to the turntable 200 and provides an adsorption force which prevents the disk D from vibrating. The disk support 700 is made of elastic material and is provided on the upper surface of the turntable 200.

In detail, the disk support 700 has a predetermined width W1 and is provided on the perimeter of the upper surface of the turntable 200. Furthermore, the disk support 700 has therein the grooves 710a which are inclined with respect to the radial direction of the turntable 200 in the direction opposite to the direction A in which the disk D rotates. The grooves 710a function as channels through which fluid S is discharged from the inside of the disk support 700 to the outside by a difference in pressure between the inside and the outside of the disk support 700 induced when the disk D rotates. Here, each groove 710a is configured such that it is inclined in the direction opposite to the direction A in which the disk D rotates, in detail, a line OC connecting the center of the turntable 200 to the inner end of the sidewall of the groove 710a is disposed ahead of a line OD connecting the center of the turntable 200 to the outer end of the sidewall thereof in the direction A in which the disk D rotates. Due to the configuration of the grooves 710a, when the disk D which is placed on the turntable 200 and is brought into close contact with the disk support 700 rotates, fluid S, that is, air, which has been between the turntable 200 and the disk D is discharged outside through the grooves 710a (refer to FIG. 4). At this time, an internal pressure Pi of the space between the turntable 200 and the disk D is reduced by the discharge of fluid, so that the space therebetween approximates a vacuum. Thereby, an adsorption force F which adsorbs the disk D towards the disk support 700 is generated by a difference between the internal pressure Pi and an external pressure Po of the air (Po>Pi). Thanks to the adsorption force F, the disk D is prevented from vibrating when rotating. In particular, when the speed at which the disk D rotates is increased, the adsorption force F is also increased, thus more reliably preventing the disk D from wobbling. If the grooves to 710a are inclined in the same direction as the direction A in which the disk D rotates, fluid is drawn into the space between the disk D and the turntable 200 when the disk D rotates. Thus, this is not preferable.

Here, each groove 710a is configured in a shape in which the entire thickness of the disk support 700 is removed such that the disk support 700 is divided into two parts based on the groove 710a. This configuration of the groove 710a may be realized by a simple process, for example, by attaching separate disk support bodies onto the turntable 200 or, alternatively, by attaching an annular disk support 700 onto the turntable 200 and cutting off a portion thereof using a cutting tool, such as a knife.

Furthermore, it is preferable that the grooves 710a be spaced apart from each other at the same angular intervals (of 360°/N, where the term N is a natural number greater than or equal to 2) and have the same shape so as to evenly generate the adsorption force F in all directions of the disk D.

In addition, it is preferable that each groove 710a be configured such that the width thereof is constant from the circumferential inner surface of the disk support 700 to the circumferential outer surface thereof, in other words, a width Di of the inner end of the groove 710a is the same as a width Do of the outer end thereof (Di=Do), or the width Do of the outer end of the groove 710a is greater than the width Di the inner end thereof (Di<Do).

As well, the groove 710a and the sidewalls of the groove 710a may be linear or curved. It is preferable that the groove 710a be curved such that it is convex in the direction A in which the disk D rotates so as to minimize the amount of fluid drawn from the outside into the space between the turntable 200 and the disk D. In other words, the groove 710a is curved in such a way that a line CD connecting the inner end of the sidewall of the groove 710a to the outer end thereof is disposed behind any point of the sidewall of the groove 710a with respect to the direction A in which the disk D rotates. If the groove 710a is curved such that it is convex in the direction opposite to the direction A in which the disk D rotates, fluid S may be undesirably drawn into the space between the turntable 200 and the disk D, because the outer end of the groove 710a which is formed in the circumferential outer surface of the disk support 700 is oriented in the direction A in which the disk D rotates. Hence, it is not preferable.

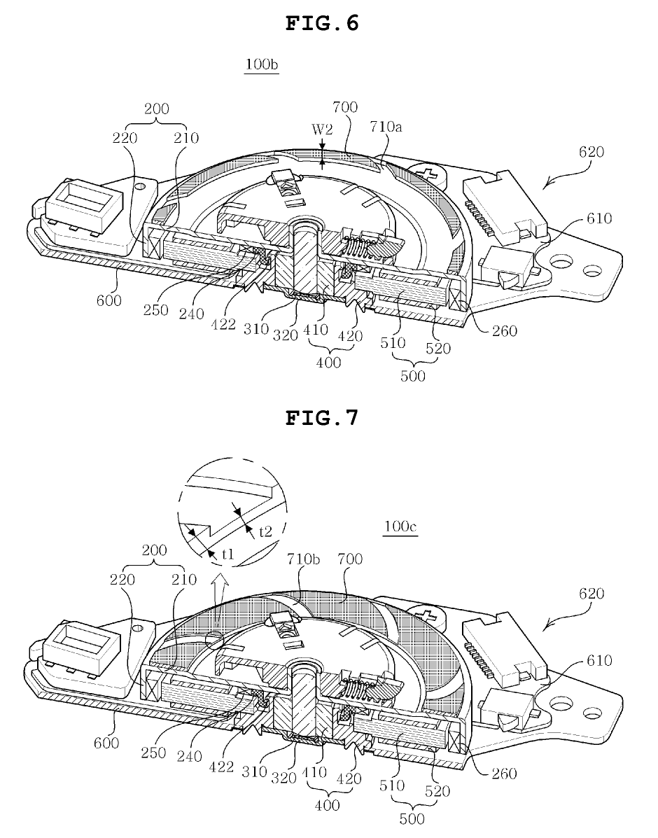

FIG. 6 is a sectional perspective view of a disk drive motor 100b, according to a second embodiment of the present invention. Hereinafter, the disk drive motor 100b according to the second embodiment of the present invention will be described with reference to FIG. 6. In the following description of the second embodiment, because the general construction of the disk drive motor 100b of the second embodiment except for a disk support 700 remains the same as that of the first embodiment, the same reference numerals will be used to designate the components corresponding to those of the first embodiment, and the explanation of the overlapped portions will be omitted.

As shown in FIG. 6, the disk drive motor 100b according to the second embodiment is configured such that a space defined between the turntable 200 and the disk D is increased to maximize a difference between internal pressure Pi of the space and external pressure Po of the air, thus increasing the adsorption force F.

The configuration of the second embodiment in which the space between the turntable 200 and the disk D is increased can be realized by reducing a width W2 of the disk support 700 compared to the width W1 of the disk support 700 of the first embodiment (W1>W2). Furthermore, the disk support 700 is attached to the perimeter of the turntable 200. It is preferable that the disk support 700 have the minimum width W2 within a range ensuring an area sufficient to prevent the disk D from slipping.

FIG. 7 is a sectional perspective view of a disk drive motor 100c, according to a third embodiment of the present invention. Hereinafter, the disk drive motor 100c according to the third embodiment of the present invention will be described with reference to FIG. 7. In the following description of the third embodiment, because the general construction of the disk drive motor 100c of the third embodiment other than a disk support 700 remains the same as that of the first embodiment, the same reference numerals will be used to designate the components corresponding to those of the first embodiment, and the explanation of the overlapped portions will be omitted.

As shown in FIG. 7, the disk drive motor 100c according to the third embodiment is characterized in that each groove 710b of the disk support 700 is formed by only partially removing a portion of the disk support 700, rendering it thinner. In other words, the disk support 700 has a single body structure and is configured such that a thickness t2 of a portion having the groove 710b is less than a thickness t1 of a portion other than the groove 710b.

The disk support 700 having the above-mentioned structure can be provided by attaching an annular disk support body on the turntable 200 and forming the grooves 710b in such a manner as to reduce the thickness of a portion of the disk support 700. In the case of such a method, a process of attaching the disk support 700 on the turntable 200 is facilitated, compared to that of the method of providing the disk support 700 in such a way as to attach separately several disk support bodies onto the turntable 200. Furthermore, because the grooves 710b are formed by reducing the thicknesses of the corresponding portions of the disk support 700, a process of forming the grooves 710b in the disk support 700 is facilitated, compared to that of the first embodiment in which the entire thickness of the disk support 700 is removed. In addition, a problem in which the upper surface of the turntable 200 may be damaged by the cutting tool during the process of forming the grooves can be minimized.

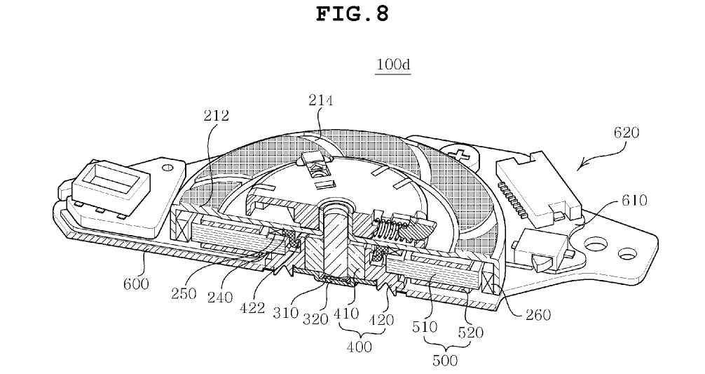

FIG. 8 is a sectional perspective view of a disk drive motor 10d, according to a fourth embodiment of the present invention. Hereinafter, the disk drive motor 100d according to the fourth embodiment of the present invention will be described with to reference to FIG. 8. In the following description of the fourth embodiment, because the general construction of the disk drive motor 100d of the fourth embodiment except for a turntable 200 and a disk support 700 remains the same as that of the first embodiment, the same reference numerals will be used to designate the components corresponding to those of the first embodiment, and the explanation of the overlapped portions will be omitted.

As shown in FIG. 8, the disk drive motor 100d according to the fourth embodiment has no a separate disk support and is configured such that grooves 214 are formed in an upper surface of a turntable 200. In this case, a disk D can be prevented from slipping with respect to the turntable 200 by an adsorption force F generated by the grooves 214 when the disk D rotates. As such, this embodiment realizes a function of adsorbing the disk D and a function of preventing the disk D from slipping using the structure such that the grooves 214 are integrally formed in the turntable 200 without having a separate disk support. Therefore, because a separate disk support is not required, the production is cost-efficient. In addition, a process of attaching the disk support to the turntable 200 is omitted, so that the production process can be simplified.

It is preferable that a perimeter 212 of the turntable 200 protrude upwards and support the disk D thereon, and a plurality of grooves 214 be formed in the protruding perimeter 212.

As described above, in a disk drive motor according to the present invention, grooves are formed in a disk support of a turntable which supports a disk thereon, the grooves being oriented in the direction opposite to the direction in which the disk rotates. Thus, when the disk rotates, fluid which has been in the space between the turntable and the disk is discharged outside through the grooves, thus creating a difference in pressure between the air and the space between the turntable and the disk. Thanks to the pressure difference, the disk can be brought into close contact with the disk support, thereby preventing the disk from wobbling when rotating. In particular, when the disk rotates at high speed, the pressure difference is further increased, so that the disk adsorption force is further increased. Therefore, operation of reading data of the disk can be more reliably conducted when the disk rotates at high speed.

Furthermore, the grooves are formed in the disk support in the same shape and at positions spaced apart from each other at same angular intervals. Hence, adsorption force can be evenly created over the entire area of the disk.

In addition, because each groove is curved such that it is convex in the direction in which the disk rotates, fluid is prevented from being drawn from the outside into the space between the turntable and the disk through the outer end of the groove.

As well, the present invention may have no separate disk support and be configured such that grooves which create a pressure difference are formed in the upper surface of the turntable. In this case, because of adsorption force generated when the disk rotates, the disk can be prevented from not only slipping with respect to the turntable but also from vibrating in the vertical direction.

Although the embodiments of the present invention have been disclosed for illustrative purposes, it will be appreciated that the disk drive motor of the invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A disk drive motor, comprising:
a turntable rotated by a drive unit, the turntable having an upper surface onto which a disk is placed;
a disk support attached to the upper surface of the turntable to support the disk thereon, with a groove formed in the disk support, the groove being inclined based on a radial direction of the turntable in a direction opposite to a direction in which the disk rotates.

2. The disk drive motor as set forth in claim 1, wherein the groove is formed by removing an entire thickness of a portion of the disk support such that the disk support is separated.

3. The disk drive motor as set forth in claim 1, wherein the groove comprises a plurality of grooves spaced apart from each other at regular angular intervals around a center of the turntable, the plurality of grooves having a same shape.

4. The disk drive motor as set forth in claim 1, wherein a width of the groove is constant from a circumferential inner surface of the disk support to a circumferential outer surface thereof or is increased from the circumferential inner surface of the disk support to the circumferential outer surface thereof.

5. The disk drive motor as set forth in claim 1, wherein sidewalls of the groove of the disk support are linear or curved.

6. The disk drive motor as set forth in claim 1, wherein the groove has a curved shape such that the groove is convex in the direction in which the disk rotates.

7. The disk drive motor as set forth in claim 1, wherein the disk support is attached to a perimeter of the turntable.

8. The disk drive motor as set forth in claim 1, wherein the groove is formed by reducing a thickness of a portion of the disk support.

9. A disk drive motor, comprising:
a turntable rotated by a drive unit, the turntable having an upper surface onto which a disk is placed, with a groove formed in the upper surface of the turntable, the groove being inclined based on a radial direction of the turntable in a direction opposite to a direction in which the disk rotates.

10. The disk drive motor as set forth in claim 9, wherein a perimeter of the upper surface of the turntable protrudes upwards, and the groove is formed in the perimeter of the upper surface of the turntable.

11. The disk drive motor as set forth in claim 9, wherein the groove comprises a plurality of grooves spaced apart from each other at regular angular intervals around a center of the turntable, the plurality of grooves having a same shape.

12. The disk drive motor as set forth in claim 9, wherein a width of the groove is constant from a circumferential inner end thereof to a circumferential outer end thereof or increases from the circumferential inner end thereof to the circumferential outer end thereof.

13. The disk drive motor as set forth in claim 9, wherein sidewalls of the groove of the turntable are linear or curved.

14. The disk drive motor as set forth in claim 9, wherein the groove has a curved shape such that the groove is convex in the direction in which the disk rotates.
